(19) United States
(12) Patent Application Publication
(10) Pub. No.: US 2026/0222747 A1
(43) Pub. Date: Jul. 30, 2026

(54) DATA EFFICIENT AND INDIVIDUALIZED AUDIO SCENE CLASSIFIER ADAPTION

(71) Applicant: MED-EL Elektromedizinische Geräte GmbH, Innsbruck (AT)

(72) Inventors: Rainer MARTIN, Bochum (DE); Timm KOPPELMANN, Bochum (DE); Semih AGCAER, Bochum (DE)

(73) Assignee: MED-EL Elektromedizinische Geräte GmbH, Innsbruck (AT)

(21) Appl. No.: 19/158,388

(22) PCT Filed: Feb. 21, 2024
(86) PCT No.: PCT/US2024/016649

§ 371 Date: Aug. 20, 2025

Related U.S. Application Data
(60) Provisional application No. 63/447,487, filed on Feb. 22, 2023.

(30) Foreign Application Priority Data
Aug. 18, 2023 (EP) 23192168.5

(51) Int. Cl. H04R 25/00; G10L 25/30; G10L 25/51

(52) U.S. Cl. CPC H04R 25/507; G10L 25/30; G10L 25/51; H04R 2225/41; H04R 2225/67

(57) ABSTRACT

A system and method of adapting audio scene classification in a hearing device. The method includes receiving at the hearing device an audio input signal. At least one feature vector is extracted from the audio input signal. The at least one feature vector are then processed at the hearing device, including using a first neural network to produce an audio scene classification output. The hearing device generates at least one stimulation signal based on the audio input signal and the audio scene classification output. Furthermore, the hearing device generates and provides to a server, a statistical aggregation of the at least one feature vector. The server processes the statistical aggregation of the at least one feature vector, including using a second neural network to produce a second audio scene classification output; The server trains a copy of the first neural network, based on the second audio scene classification output, to generate updated parameters for the first neural network; The server provides these updated parameters to the hearing device, which then updates the first neural network with the updated parameters.

### CROSS-REFERENCE TO RELATED APPLICATIONS

This application claims priority from both U.S. Provisional Application 63/447,487, filed Feb. 22, 2023, and European Patent Application EP23192168.5 filed Aug. 18, 2023, both of which are hereby incorporated herein by reference in their entirety.

### TECHNICAL FIELD

The present invention relates to audio scene classifier adaptation, and more particularly, neural network scene classification adaptation in hearing devices, such as hearing aids and cochlear implants, using a server, e.g. a cloud-based server.

### BACKGROUND ART

A normal ear transmits sounds as shown in FIG. 1 (prior art) through the outer ear 101 to the tympanic membrane 102, which moves the ossicles of the middle ear 103 (malleus, incus, and stapes) that vibrate the oval window and round window openings of the cochlea 104. The cochlea 104 is a long narrow duct wound spirally about its axis for approximately two and a half turns. It includes an upper channel known as the scala vestibuli and a lower channel known as the scala tympani, which are connected by the cochlear duct. The cochlea 104 forms an upright spiraling cone with a center called the modiolar where the spiral ganglion cells of the acoustic nerve 113 reside. In response to received sounds transmitted by the middle ear 103, the fluid-filled cochlea 104 functions as a transducer to generate electric pulses which are transmitted to the cochlear nerve 113, and ultimately to the brain.

Hearing is impaired when there are problems in the ability to transduce external sounds into meaningful action potentials along the neural substrate of the cochlea 104. To improve impaired hearing, hearing prostheses have been developed. For example, when the impairment is related to operation of the middle ear 103, a conventional hearing aid may be used to provide mechanical stimulation to the auditory system in the form of amplified sound. Or when the impairment is associated with the cochlea 104, a cochlear implant with an implanted stimulation electrode can electrically stimulate auditory nerve tissue with small currents delivered by multiple electrode contacts distributed along the electrode.

FIG. 1 also shows some components of a typical cochlear implant system, including an external microphone that provides an audio signal input to an external signal processor 111 where various signal processing schemes can be implemented. The processed signal is converted into a digital data format, such as a sequence of data frames, for transmission into the implant 108. Besides receiving the processed audio information, the implant 108 also performs additional signal processing such as error correction, pulse formation, etc., and produces a stimulation pattern (based on the extracted audio information) that is sent through an electrode lead 109 to an implanted electrode array 110.

Typically, the electrode array 110 includes multiple electrode contacts 112 on its surface that provide selective stimulation of the cochlea 104. Depending on context, the electrode contacts 112 are also referred to as electrode channels. In cochlear implants today, a relatively small number of electrode channels are each associated with relatively broad frequency bands, with each electrode contact 112 addressing a group of neurons with an electric stimulation pulse having a charge that is derived from the instantaneous amplitude of the signal envelope within that frequency band.

In some stimulation signal coding strategies, stimulation pulses are applied at a constant rate across all electrode channels, whereas in other coding strategies, stimulation pulses are applied at a channel-specific rate. Various specific signal processing schemes can be implemented to produce the electrical stimulation signals. Signal processing approaches that are well-known in the field of cochlear implants include continuous interleaved sampling (CIS), channel specific sampling sequences (CSSS) (as described in U.S. Pat. No. 6,348,070, hereby incorporated herein by reference), Fine Structure Processing (FSP) strategy spectral peak (SPEAK), and compressed analog (CA) processing.

In the CIS strategy, the signal processor only uses the band pass signal envelopes for further processing, i.e., they contain the entire stimulation information. For each electrode channel, the signal envelope is represented as a sequence of biphasic pulses at a constant repetition rate. A characteristic feature of CIS is that the stimulation rate is equal for all electrode channels and there is no relation to the center frequencies of the individual channels. It is intended that the pulse repetition rate is not a temporal cue for the patient (i.e., it should be sufficiently high so that the patient does not perceive tones with a frequency equal to the pulse repetition rate). The pulse repetition rate is usually chosen at greater than twice the bandwidth of the envelope signals (based on the Nyquist theorem).

In a CIS system, the stimulation pulses are applied in a strictly non-overlapping sequence. Thus, as a typical CIS-feature, only one electrode channel is active at a time and the overall stimulation rate is comparatively high. For example, assuming an overall stimulation rate of 18 kpps and a 12 channel filter bank, the stimulation rate per channel is 1.5 kpps. Such a stimulation rate per channel usually is sufficient for adequate temporal representation of the envelope signal. The maximum overall stimulation rate is limited by the minimum phase duration per pulse. The phase duration cannot be arbitrarily short because, the shorter the pulses, the higher the current amplitudes have to be to elicit action potentials in neurons, and current amplitudes are limited for various practical reasons. For an overall stimulation rate of 18 kpps, the phase duration is 27 μs, which is near the lower limit.

The Fine Structure Processing (FSP) strategy by Med-El uses CIS in higher frequency channels, and uses fine structure information present in the band pass signals in the lower frequency, more apical electrode channels. In the FSP electrode channels, the zero crossings of the band pass filtered time signals are tracked, and at each negative to positive zero crossing, a Channel Specific Sampling Sequence (CSSS) is started. Typically CSSS sequences are applied on up to 3 of the most apical electrode channels, covering the frequency range up to 200 or 330 Hz. The FSP arrangement is described further in Hochmair I, Nopp P, Jolly C, Schmidt M, Schößer H, Garnham C, Anderson I, MED-EL Cochlear Implants: State of the Art and a Glimpse into the Future, Trends in Amplification, vol. 10, 201-219, 2006, which is hereby incorporated herein by reference. The FS4 coding strategy differs from FSP in that up to 4 apical channels can have their fine structure information used. In FS4-p, stimulation pulse sequences can be delivered in parallel on any 2 of the 4 FSP electrode channels. With the FSP and FS4 coding strategies, the fine structure information is the instantaneous frequency information of a given electrode channel, which may provide users with an improved hearing sensation, better speech understanding and enhanced perceptual audio quality. See, e.g., U.S. Pat. No. 7,561,709; Lorens et al. “Fine structure processing improves speech perception as well as objective and subjective benefits in pediatric MED-EL COMBI 40+ users.” International journal of pediatric otorhinolaryngology 74.12 (2010): 1372-1378; and Vermeire et al., “Better speech recognition in noise with the fine structure processing coding strategy.” ORL 72.6 (2010): 305-311; all of which are hereby incorporated herein by reference in their entireties.

Many cochlear implant coding strategies use what is referred to as an n-of-m approach where only some number n electrode channels with the greatest amplitude are stimulated in a given sampling time frame. If, for a given time frame, the amplitude of a specific electrode channel remains higher than the amplitudes of other channels, then that channel will be selected for the whole time frame. Subsequently, the number of electrode channels that are available for coding information is reduced by one, which results in a clustering of stimulation pulses. Thus, fewer electrode channels are available for coding important temporal and spectral properties of the sound signal such as speech onset.

In addition to the specific processing and coding approaches discussed above, different specific pulse stimulation modes are possible to deliver the stimulation pulses with specific electrodes—i.e. mono-polar, bi-polar, tri-polar, multi-polar, and phased-array stimulation. And there also are different stimulation pulse shapes—i.e. biphasic, symmetric triphasic, asymmetric triphasic pulses, or asymmetric pulse shapes. These various pulse stimulation modes and pulse shapes each provide different benefits; for example, higher tonotopic selectivity, smaller electrical thresholds, higher electric dynamic range, less unwanted side-effects such as facial nerve stimulation, etc.

Fine structure coding strategies such as FSP and FS4 use the zero-crossings of the band-pass signals to start a channel-specific sampling sequence (CSSS) pulse sequences for delivery to the corresponding electrode contact. Zero-crossings reflect the dominant instantaneous frequency quite robustly in the absence of other spectral components. But in the presence of higher harmonics and noise, problems can arise. See, e.g., WO 2010/085477 and Gerhard, David, Pitch extraction and fundamental frequency: History and current techniques, Regina: Department of Computer Science, University of Regina, 2003; both hereby incorporated herein by reference in their entireties.

Cochlear implant users, and hearing aid users in general, are often exposed to a wide variety of sound environments. These environments include, for example, noisy environments, conversation in speech, a (quiet) living room, a conference, music, a restaurant, a car, a street, an office, sports stadiums and combinations thereof. Various techniques are known and used to classify a user's sound environment, e.g., the Bayesian classifier, the Hidden Markov Model (HMM), and Gaussian Mixture Model (GMM). Based on the classified sound environment, hearing aid devices can apply parameter settings appropriate for that particular sound environment and thus improve a user's listening experience.

FIG. 2 shows a functional schematic of a conventional signal processing system that uses audio scene classification (ASC) when generating stimulation signals for a hearing implant. An external signal processor 200 includes an audio scene classifier 201 that utilizes a neural network 203 configured to produce an audio scene classification output based on scene classification parameters. A processor 202 is configured for processing the audio input signal and the output of the audio scene classifier 201 to generate stimulation signals to a pulse generator 204 that are then provided to the hearing implant 205 for perception of sound by the patient. See, for example, U.S. Patent Publication 2021/0174824, which is hereby incorporated herein by reference in its entirety.

Conventional methodologies for audio scene classification (ASC) have the disadvantage that they are either not adapted to that particular individual's environment, need to be extended to a previously unseen signal category and/or often require large data manipulation, which often demands data protection due to privacy concerns. Cochlear implant systems and other hearing devices often have limited storage and processing capacities. Furthermore, cochlear implant users are faced with a wide variety of different acoustic environments, which may be referred to as audio or acoustic scene or environment in the following.

### SUMMARY OF THE INVENTION

Embodiments of the present invention are directed to a system and method of adapting audio scene classification in a hearing device. The method includes receiving at the hearing device an audio input signal. At least one feature vector is extracted from the audio input signal. The at least one feature vector is then processed at the hearing device, including using a first classifier to produce audio scene classification outputs. The hearing device generates at least one stimulation signal based on the audio input signal and the audio scene classification outputs. Furthermore, the hearing device generates a statistical aggregation of the at least one feature vector and provides to a server, the statistical aggregation of the at least one feature vector. The server generates new feature vectors from the received statistical aggregation of the at least one feature vector based on expanding extrapolating the statistical aggregation of the at least one feature vector into a statistical distribution and sampling from this distribution to produce extrapolated feature vectors for input to a second classifier to produce a second audio scene classification output. The server re-trains the first classifier, based on the output of the second audio scene classification output to generate updated parameters for the first classifier; The server provides these updated parameters to the hearing device, which then updates the first classifier with the updated parameters.

In accordance with related embodiment of the invention, providing the statistical aggregation of the at least one feature vector to the server may occur at random intervals, user controlled or at periodic intervals, such as hourly, daily or monthly. The statistical aggregation of the at least one feature vector may also occur when a new acoustic environment is encountered. The statistical aggregation of the at least one feature vector may include a standard deviation and/or mean value and/or a covariance matrix and/or a covariance and/or higher order statistical moments and/or average energy and/or audio scene classification output from the first classifier. The statistical aggregation of the feature vector may be General Data Protection Regulation (GDPR) compliant. Training at the server may be based, at least in part, on extrapolated feature vectors. Expanding extrapolating the statistical aggregation of the as least one feature vector into a statistical distribution and sampling from this distribution to produce extrapolated feature vectors may be based on a mixture model, such as e.g. a Gaussian Mixture Model (GMM).

In accordance with further related embodiments of the invention, the hearing device may be a hearing aid, a middle ear implant, a bone conduction implant or a cochlear implant. The audio scene classification output may be by way of example, without limitation one or more of the following audio scenes: a living room, a conference, a restaurant, a car, an office, sports or combinations thereof. The second classifier may be a deep neural network. The first classifier may include a neural network, linear discriminant analysis (LDA) classifier and/or a support vector machine (SVM). The feature vectors may include Mel-Frequency Cepstral Coefficients (MFCCs), convolutional neural network (CNN) features, Amplitude Modulation Spectrum (AMS) features and/or low-level features like zero-crossing rates, spectral statistics and/or timbre.

In accordance with another embodiment of the invention, a hearing system for generating stimulation signals includes a hearing device having a signal processor. The signal processor is configured to: extract at least one feature vector from an audio input signal received by the hearing device; process the feature vectors using a first classifier to produce an audio scene classification output; generate at least one stimulation signal based on the audio input signal and the hearing device audio scene classification output; generate a statistical aggregation of the feature vectors; and transmit the statistical aggregation. The hearing system further includes a server. The server is configured to: receive the statistical aggregation of the at least one feature vector; process the statistical aggregation of the at least one feature vector, the processing of the statistical aggregation of the at least one feature vector including expanding extrapolating the statistical aggregation of the at least one feature vector into a statistical distribution and sampling from this distribution to produce extrapolated feature vectors for input to a second classifier to produce a second audio scene classification output; train a copy of the first classifier based on the second audio scene classification output to generate updated parameters for the first classifier; and transmit the updated parameters to the hearing device. The signal processor is configured to update the first classifier based on the updated parameters.

In accordance with related embodiment of the invention, providing the statistical aggregation of the at least one feature vector to the server may occur at random intervals, user controlled or at periodic intervals, such as hourly, daily or monthly. The statistical aggregation of the at least one feature vector may also occur when a new acoustic environment is encountered. The statistical aggregation of the at least one feature vector may include a standard deviation and/or mean value and/or a covariance matrix and/or higher order statistical moments and/or average energy and/or audio scene classification output from the first classifier. The statistical aggregation of the at least one feature vector may be General Data Protection Regulation (GDPR) compliant. Training a copy of the first classifier at the server may include, at least in part, on extrapolated feature vectors. Expanding extrapolating the statistical aggregation of the at least one feature vector into a statistical distribution and sampling to produce extrapolated feature vectors may include a mixture model, such as e.g. a Gaussian Mixture Model (GMM).

In accordance with further related embodiments of the invention, the hearing device may be a hearing aid, a middle ear implant or a cochlear implant. The audio scene classification output may be by way of example, without limitation one or more of the following audio scenes: a living room, a conference, a restaurant, a car, an office, sports or combinations thereof. The second classifier may be a deep neural network. The first classifier may include a neural network, linear discriminant analysis (LDA) classifier and/or a support vector machine (SVM). The feature vectors may include Mel-Frequency Cepstral Coefficients (MFCCs), convolutional neural network (CNN) features, Amplitude Modulation Spectrum (AMS) features and/or low-level features like zero-crossing rates, spectral statistics and/or timbre.

In accordance with another embodiment of the invention, a hearing device for generating stimulation signals includes a signal processor. The signal processor is configured to extract at least one feature vector from an audio input signal received by the hearing device; process the feature vectors using a first neural network to produce a hearing device audio scene classification output; generate at least one stimulation signal based on the audio input signal and the hearing device audio scene classification output; generate a statistical aggregation of the at least one feature vector; provide to a server a statistical aggregation of the at least one feature vector; receive updated parameters for the first neural network from the server; and update the first neural network with the updated parameters.

In accordance with related embodiments of the invention, the signal processor may be configured to provide the statistical aggregation of the at least one feature vector at periodic intervals. The signal processor may be configured to provide the statistical aggregation of the at least one feature vector when it is determined that a new acoustic environment is encountered. The statistical aggregation of the at least one feature vector may include a standard deviation and/or a mean value and/or covariance and/or higher order statistical moments and/or average energy and/or audio scene classification output from the first neural network. The hearing device may be a hearing aid, a middle ear implant, or a cochlear implant.

In accordance with a further embodiment of the invention, a server for updating a first classifier of a hearing device is provided, the first classifier producing a hearing device audio scene classification output based on at least one feature vector characterizing an audio input signal received at the hearing device. The server includes a server application configured to: receive the statistical aggregation of the at least one feature vector from the hearing device; process the statistical aggregation of the at least one feature vector, the processing of the statistical aggregation of the at least one feature vector including expanding extrapolating the statistical aggregation of the at least one feature vector into a statistical distribution and sampling from this distribution to produce extrapolated feature vectors for input to a second classifier to produce a second audio scene classification output; train a copy of the first classifier based on the second audio scene classification output to generate updated parameters for the first classifier; and provide to the hearing device the updated parameters for the first classifier.

The server may be configured to utilize a mixture model, e.g. a Gaussian Mixture Model (GMM) when extrapolating the statistical aggregation of the at least one feature vector into a statistical distribution and sampling to produce extrapolated feature vectors. The second classifier may be a deep neural network.

In accordance with another embodiment of the invention, a method of generating stimulation signals in a hearing device is provided. The method includes extracting, at the hearing device, at least one feature vector from an audio input signal received by the hearing device. The feature vectors are processed, at the hearing device, using a first neural network to produce an audio scene classification output. At least one stimulation signal is generated, at the hearing device, based on the audio input signal and the hearing device audio scene classification output. A statistical aggregation of the at least one feature vector is generated at the hearing device and provided to a server. Updated parameters for the first neural network are received by the hearing device from the server. The first neural network, at the hearing device, is updated with the updated parameters.

In accordance with related embodiments of the invention, the hearing device may be a hearing aid, a middle ear implant or a cochlear implant. Providing the statistical aggregation of the at least one feature vector may occur at periodic intervals. Providing the statistical aggregation of the at least one feature vector may occur when it is determined that a new acoustic environment is encountered. The statistical data may include a standard deviation and/or mean value.

In accordance with another embodiment of the invention, a method for updating a first neural network of a hearing device is provided. The first neural network produces a hearing device audio scene classification output based on at least one feature vector characterizing an audio input signal received at the hearing device. The method includes receiving, at the server, a statistical aggregation of the at least one feature vector from the hearing device; processing, at the server, the statistical aggregation of the at least one feature vector, the processing of the statistical aggregation of the at least one feature vector including expanding extrapolating the statistical aggregation of the at least one feature vector into a statistical distribution and sampling from this distribution to produce extrapolated feature vectors for input to a second neural network to produce a second audio scene classification output; training, at the server, a copy of the first neural network based on the second audio scene classification output to generate updated parameters for the first neural network; and providing, by the server, to the hearing device the updated parameters for the first neural network.

Extrapolating the statistical aggregation of the at least one feature vector into a statistical distribution and sampling from this distribution to produce extrapolated feature vectors may include using a mixture model, e.g. a Gaussian Mixture Model (GMM). The second neural network may be a deep neural network.

### BRIEF DESCRIPTION OF THE DRAWINGS

The foregoing features of embodiments will be more readily understood by reference to the following detailed description, taken with reference to the accompanying drawings, in which:

FIG. 1 (prior art) shows the anatomy of a typical human ear and components in a cochlear implant system;

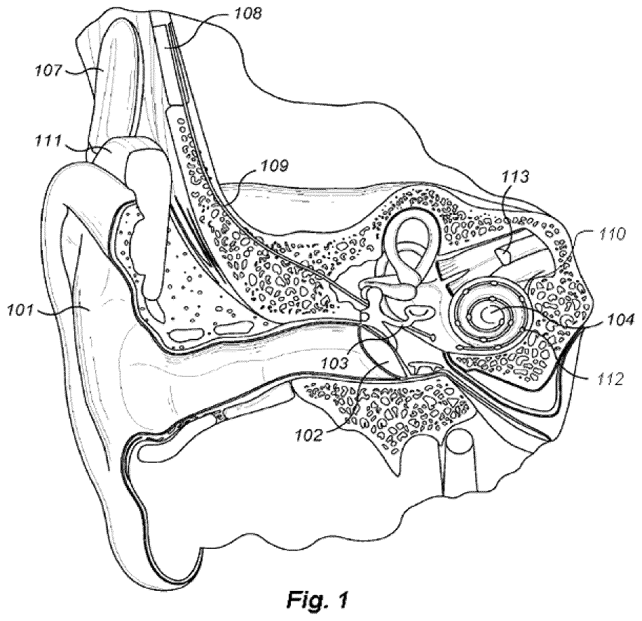

FIG. 2 (prior art) shows a functional schematic of a conventional signal processing system that uses audio scene classification (ASC) when generating stimulation signals for a hearing implant implanted in a user; and

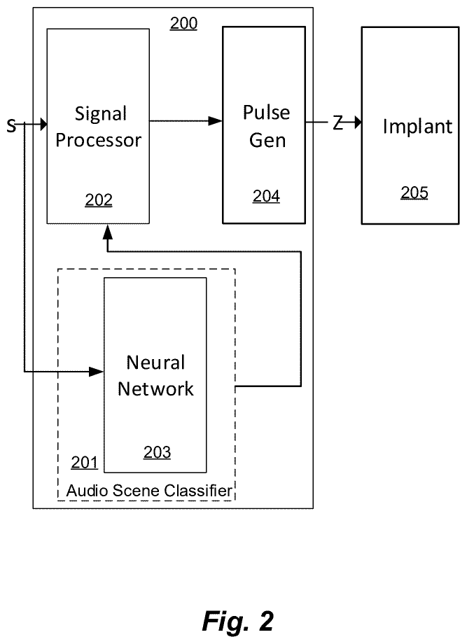

FIG. 3 shows a functional schematic of a hearing system with adaptive audio scene classification, in accordance with an embodiment of the invention.

### DETAILED DESCRIPTION OF SPECIFIC EMBODIMENTS

In illustrative embodiments of the invention, systems and methodologies for adapting audio scene classifiers in devices with, for example, limited computing and/or storage capability are provided. For example, scene-based audio analysis/classification in hearing devices, such as cochlear implants, can be adapted to the user's existing environment. This is advantageously accomplished with minimal computing and memory requirements in the hearing device, without direct interaction from the user. To solve the problem of limited storage and processing capacities an external server is employed, whereas the data communicated between the hearing device and the server is aggregated, with low data rates between the device and a server, and such that privacy is protected. Details are provided below.

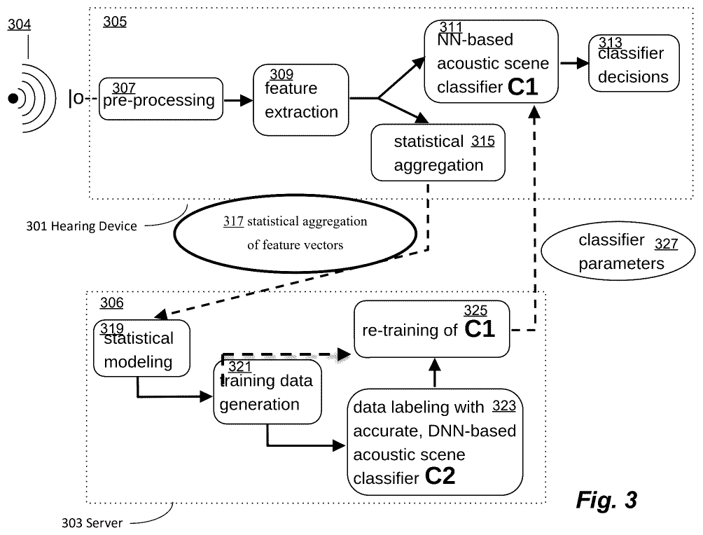

FIG. 3 shows a functional schematic of a hearing system with adaptive audio scene classification, according to an embodiment of the present invention. The system includes a hearing device 301. Hearing device 301 may be, without limitation, a hearing aid and/or a hearing implant. The hearing implant may be, without limitation, a cochlear implant, in which the electrodes of a multichannel electrode array are positioned such that they are, for example, spatially divided within the cochlea. The cochlear implant may be partially implanted, and include, without limitation, an external speech/signal processor, microphone and/or coil, with an implanted stimulator and/or electrode array. In other embodiments, the cochlear implant may be a totally implanted cochlear implant. In further embodiments, the multi-channel electrode may be associated with a brainstem implant, such as an auditory brainstem implant (ABI).

The hearing device 301 includes a signal processor 305. The signal processor 305 is configured to perform various preprocessing strategies/functions on the audio signal input 350 as well as processing steps according to embodiments of the present invention, as described above without limitation. Additionally, the signal processor 305 includes a feature extraction module 309 and a classification module 311.

The feature extraction module 309 generates a set of audio features, which may, for example, include a feature vector(s), based on the audio input 304. The feature vector may include, for example, Mel-Frequency Cepstral Coefficients (MFCCs), convolutional neural network (CNN) features, or Amplitude Modulation Spectrum (AMS) features. These features may be fixed and predefined (MFCCs), or trained on specific datasets for maximum performance and minimum computational effort (CNN or AMS). The feature vector may comprise a set of feature vectors, e.g. a set where each feature vector is generated based on timely consecutive audio input 304. The timely consecutive audio input 304 for generating feature vectors may at least partly overlap. In one example, the feature vector may include 5 feature vectors and each feature vector is generated based on a 2 second duration audio input 304. The feature vectors of any of the forgoing examples include sufficient information from the audio signal, to revert from the statistical aggregation of the at least one feature vector 317 by extrapolating artificial feature vectors (point) representative of the audio signals (points) based on the statistical aggregation of the at least one feature vector 317 and a given distribution model. Such generated artificial feature vectors are statistically representative of the audio signals that are typically heard by the user in the user-specific acoustic environment and can be used to train a neural network, but in itself are no audio signals. The sequence of generated artificial feature vectors may not represent the sequence of feature vectors as would be derived from ambient audio signals but resembles the statistical properties and distribution only.

The at least one feature vector is then passed to the classification module 311, which may be based on a linear discriminant classifier, a support vector machine (SVM), a (deep) neural network, or a combination of these or other classification techniques. In a specific embodiment, a data-driven AMS feature extractor may be combined with a (first) deep neural network classification module to output an audio scene classification output 313.

Upon determination of the audio scene classification output 313, the hearing device 301 may then apply parameter settings that are appropriate for that particular sound environment and thus improve a user's listening experience. Illustratively, the audio input signal 304 and the output of the audio scene classifier 313 are used by the hearing device 301 to generate stimulation signals that may then be provided to the hearing implant for perception of sound by the patient.

This configuration of feature extraction module 309 and classification module 313, which includes, for example, a first classifier, can advantageously be trained and fully adapted to one or more acoustic environments. In illustrative embodiments of the invention, adaptation of the classification module 311 is provided after this system has been delivered to a cochlear implant (or other hearing device) user in order to account for user-specific acoustic environments that are encountered. For example, the user may be exposed to different environments and situations over the course of the day. These different environments may include a living room (e.g., listening to radio, watching TV . . . ), driving to work (e.g., car, street . . . ), an office (e.g., talking, keyboard sounds . . . ) and/or sports (e.g., jogging outside in the park, a stadium).

The extracted feature vectors may be statistically aggregated 315 in terms of, without limitation, audio scene classification output from the audio scene classifier 313 or statistical moments, for example: means, covariances, average energy and higher order statistical moments, which may then be stored within the hearing device 301 (e.g. cochlear implants) internal memory, thereby obtaining statistical aggregation of the at least one feature vector 317. In a preferred embodiment, the statistical aggregation of the at least one feature vector 317 starts anew, when the audio scene classifier 313 detects that the encountered acoustic environment has changed. For example, audio scene classifier 313 detects a change of the existing acoustic environment of the user, and its output would indicate a changed pre-dominant audio scene, then this would trigger starting statistical aggregation of the at least one feature vector 317 anew. This has the advantage, that the statistically aggregated 315 feature vectors are derived from feature vectors 317 of the same audio scene, which can be understood to be in the same region of the feature vector space.

A change of audio scene or environment may be detected based on the comparison of statistical aggregates from the feature vectors or AMS over a short time span and a long time span, the long time span encompasses the short time span. The statistical aggregates may be the mean value (μₛₕₒᵣₜ, μ_{long}), the variance or standard deviation or the covariance matrix (Σₛₕₒᵣₜ, Σ_{long}). A change of audio scene may then be detected, e.g. when the statistical aggregates from the long time span and short time span differ more than a certain threshold or when a calculated value from the statistical aggregates exceed a certain threshold. Such a calculated value may be a Mahalanobis distance and calculated according to:

$${d}_{mah} = \sqrt{{( {μ}_{short} - {μ}_{long} )}^{T} {Σ}_{long}^{- 1} ( {μ}_{short} - {μ}_{long} )} .$$

Other methods for statistical aggregation of the at least one feature vector 317 that do not require detection of scene changes may equally be utilized. Such as e.g. described in “Sketching for large-scale learning of mixture models”, Nicolas Keriven, Theses at the Université de Rennes, 2017, which is incorporated herein by reference. If such methods for statistical aggregation of the at least one feature vector 317 are used, the statistical aggregation of the at least one feature vector 317 may not start anew.

At pre-defined intervals, these statistical aggregations will be transmitted to, and received by, an application 306 on a server 303, via a wireless or wireline connection, whereby the statistical aggregation 315 can be used for determining adaptation of the cochlear implant (or other hearing device) classification module 311. The pre-defined interval may be, without limitation, hourly, daily or monthly. Alternatively, instead of a pre-defined interval, the statistical aggregation 315 may be provided to the server 303 when a certain condition is met. For example, if desired by the user, or adaptive dependent on the status of training of classification module 311. For example, during initial training and adaptation of classification module 311 or when the user-specific acoustic environment has changed (e.g. when the user is on vacation) the statistical aggregation 315 may be provided to the server 303 more often, while during regular use the statistical aggregation 315 may be provided to the server 303 less frequent.

Sending a statistical aggregation of the feature vector to the server 303, instead of the entire feature vector itself, advantageously reduces the size of the vector-making the following communication to the server 303 data efficient. Only statistical data of the feature vector, such as the standard deviation, mean value, etc. may be communicated to the server. Since no “raw” data is communicated to the server, this also means that the data on the server is anonymous or General Data Protection Regulation (GDPR) compliant.

In various embodiments, the server 303 performs processing, such as statistical modeling 319, on the received statistical aggregation of the at least one feature vector 317. For example, the server 303 may be configured to revert the received statistical aggregation of the at least one feature vector 317 by extrapolating points based on the statistical aggregation of the at least one feature vector 317 and a given distribution model. The given distribution model may be, without limitation, a Gaussian or a heavy-tailed distribution model, a mixture model such as a Gaussian Mixture Model (GMM), or a neural-network-based model. The Gaussian Mixture Model (GMM) may be represented through

$$p ( x ) = {\sum }_{i = 1}^{N} {α}_{i} 𝒩 ( x , {μ}_{i} , {Σ}_{i} )$$

where x represents a feature vector and p(x) the probability for the specific feature vector x, the mean feature vectors μᵢ, the covariance matrix Σᵢ, the weights at each for the N components (dimensions). [symbol] (.) represents the probability density function for the normal distribution and the weights αᵢ may be normalized, i.e.

$${\sum }_{i = 1}^{N} {α}_{i} = 1 .$$

Any of these models may be statistically sampled in order to generate specific instances of acoustic feature sets 321 representing audio features from the captured acoustic environments of the user.

These artificially generated training samples may then be fed into and labeled by an accurate, cloud- or server-based classifier 323 at server 303. In illustrative embodiments, this classifier 323 may include a deep neural network. This deep neural network may have millions of parameters, and advantageously be more powerful than the acoustic scene classifier 311 located in the hearing device 301 (which has limited resources due to space and power constraints).

The output of the cloud- or server-based classifier 323 (i.e., the second audio scene classification output) may be a labeled dataset which is then combined with the existing training base to train a copy of the first classifier 325 that is embedded at the server 303. Subsequently, one or several modules of the embedded copy of the first classifier 325 will be re-trained, with the updated classifier parameters 327 transmitted back to the user's hearing device 301. The signal processor 305 is configured to update the first classifier 311 based on the updated parameters 327 received from the server 303.

After performing the re-training, the user's audio classifier 311 has improved its capability of classifying sounds within the previously captured user-specific situations (for instance living room, car, office, and sports). As indicated above, this process may be repeated whenever specific new environments are encountered, or at predetermined times. Variations in user environment may be monitored via additional data derived from positioning systems, or via a comparison between data aggregated in the hearing device 301 and data available at the cloud- or server-based server 303.

Embodiments of the invention may be implemented in part in any conventional computer programming language. For example, preferred embodiments may be implemented in a procedural programming language (e.g., “C”) or an object oriented programming language (e.g., “C++”, Python). Alternative embodiments of the invention may be implemented as pre-programmed hardware elements, other related components, or as a combination of hardware and software components.

Embodiments can be implemented in part as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or analog communications lines) or a medium implemented with wireless techniques (e.g., microwave, infrared or other transmission techniques). The series of computer instructions embodies all or part of the functionality previously described herein with respect to the system. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software (e.g., a computer program product).

Although various exemplary embodiments of the invention have been disclosed, it should be apparent to those skilled in the art that various changes and modifications can be made which will achieve some of the advantages of the invention without departing from the true scope of the invention.

1. A method of adapting audio scene classification in a hearing device, the method comprising:
receiving, at the hearing device, an audio input signal;
extracting, at the hearing device, at least one feature vector from the audio input signal;
processing, at the hearing device, the at least one feature vector, the processing at the hearing device including using a first classifier to produce an audio scene classification output;
generating, at the hearing device, at least one stimulation signal based on the audio input signal and the audio scene classification output;
generating, at the hearing device, a statistical aggregation of the at least one feature vector;
providing, by the hearing device, to a server, the statistical aggregation of the at least one feature vector;
processing at the server the statistical aggregation of the at least one feature vector, the processing at the server includes expanding extrapolating the statistical aggregation of the at least one feature vector into a statistical distribution and sampling from this distribution to produce extrapolated feature vectors for input to a second classifier to produce a second audio scene classification output;
training, at the server, a copy of the first classifier based on the second audio scene classification output, to generate updated parameters for the first classifier;
providing, by the server, to the hearing device, the updated parameters; and
updating, at the hearing device, the first classifier with the updated parameters.

2. The method of claim 1, wherein providing the statistical aggregation of the feature vectors occurs at periodic intervals or when it is determined that a new acoustic environment is encountered.

3. The method of claim 2, wherein the periodic intervals is one of daily and monthly.

4. (canceled)

5. The method of claim 1, wherein the hearing device is one of a hearing aid, a middle ear implant, a bone conduction implant and a cochlear implant.

6. The method of claim 1, wherein the statistical aggregation of the at least one feature vector includes a standard deviation and/or mean value and/or a covariance and/or higher order statistical moments and/or average energy and/or audio scene classification output from the first classifier.

7. The method of claim 1, wherein the statistical aggregation of the feature vectors is General Data Protection Regulation (GDPR) compliant.

8. The method of claim 1, wherein training, at the server, is additionally, as least in part, based on extrapolated feature vectors.

9. The method of claim 1, wherein for expanding extrapolating the statistical aggregation of the as least one feature vector into a statistical distribution and sampling from this distribution to produce extrapolated feature vectors is based on a mixture model, e.g. a Gaussian Mixture Model (GMM).

10. (canceled)

11. (canceled)

12. The method of claim 1, wherein the first classifier comprises a linear discriminant analysis (LDA) classifier and/or a support vector machine (SVM) and/or a neural network, and the second classifier is a deep neural network.

13. The method of claim 1, wherein the feature vector includes Mel-Frequency Cepstral Coefficients (MFCCs), convolutional neural network (CNN) features, or Amplitude Modulation Spectrum (AMS) features.

14. A hearing system for generating stimulation signals comprising:
a hearing device including a signal processor, the signal processor configured to:
extract at least one feature vector from an audio input signal received by the hearing device;
process the at least one feature vector using a first neural network to produce an audio scene classification output;
generate at least one stimulation signal based on the audio input signal and the hearing device audio scene classification output;
generate a statistical aggregation of the at least one feature vector; and transmit the statistical aggregation; and
a server configured to:
receive the statistical aggregation of the at least one feature vector;
process the statistical aggregation of the at least one feature vector, the-processing of the statistical aggregation of the at least one feature vector includes expanding extrapolating the statistical aggregation of the at least one feature vector into a statistical distribution and sampling from this distribution to produce extrapolated feature vectors for input to a second neural network to produce a second audio scene classification output;
train a copy of the first classifier based on the second audio scene classification output to generate updated parameters for the first classifier; and
transmit the updated parameters to the hearing device,
wherein the signal processor is configured to update the first classifier based on the updated parameters.

15. (canceled)

16. The hearing system according to claim 14, wherein the signal processor is configured to provide the statistical aggregation of the at least one feature vector at periodic intervals.

17. The hearing system according to claim 14, wherein the signal processor is configured to provide the statistical aggregation of the at least one feature vector occurs when it is determined that a new acoustic environment is encountered.

18. The hearing system according to claim 14, wherein the statistical aggregation of the at least one feature vector includes a standard deviation and/or mean value and/or covariance and/or higher order statistical moments and/or average energy and/or audio scene classification output from the first classifier.

19. The hearing system according to claim 14, wherein the statistical aggregation of the at least one feature vector is General Data Protection Regulation (GDPR) compliant.

20. The hearing system according to claim 14, wherein the server is configured to train a copy of the first classifier additionally based, at least in part, on extrapolated feature vectors.

21. The hearing system according to claim 14, wherein the server is configured to utilize a mixture model, e.g. a Gaussian Mixture Model (GMM) when expanding extrapolating the statistical aggregation of the at least one feature vector into a statistical distribution and sampling to produce extrapolated feature vectors.

22. The hearing system according to claim 14, wherein the audio scene classification output is an audio scene selected from the group of audio scenes consisting of a living room, a conference, a restaurant, a car, an office, sports and combinations thereof.

23. (canceled)

24. The hearing system according to claim 14, wherein the first neural network comprises a linear discriminant analysis (LDA) classifier and/or a support vector machine (SVM) and the second neural network is a deep neural network.

25. The hearing system according to claim 14, wherein the feature vector includes Mel-Frequency Cepstral Coefficients (MFCCs), convolutional neural network (CNN) features, or Amplitude Modulation Spectrum (AMS) features.

26-41. (canceled)
